(19) United States
(12) Patent Application Publication
(10) Pub. No.: US 2011/0305516 A1
(43) Pub. Date: Dec. 15, 2011

(54) Hydraulically impervious earthen pond

(76) Inventor: Andrew Brosenitsch, Cabot, PA (US)

(21) Appl. No.: 12/802,720

(22) Filed: Jun. 14, 2010

(51) Int. Cl. B65G 5/00

(52) U.S. Cl. 405/57; 405/53

(57) ABSTRACT

A hydraulically impervious earth excavated pond and method of forming the pond. The pond includes a shaped man-made excavated pond basin having sides and a base. An impermeable hardened foam sealant supporting damaging inhibitors is secured to the sides of the pond basin. The inhibitor is a root inhibitor and/or rodent inhibitor/repellant. A resilient liquid impermeable membrane covers the sealant and base of the pond basin.

### BACKGROUND OF THE INVENTION

1. Field of Invention

This invention relates to a substantially hydraulically impervious pond and the method of forming the pond.

2. Description of Prior Art

In water confining excavated formations such as ponds, water gardens, and such like, the prevention of water leakage has long been known. One method of leakage prevention has been to line the excavated pond basin with only a rubber or plastic membrane. Another method has been to form linings of various clay-like mixtures such as bentonite or other expanding lattice mixtures. Phosphate slimes and industrial liquid waste materials mixed with loose earth have been used to form linings in waste disposal basins. Reconstituted shale found beneath limestone quarries has been used as impermeable liners in sanitary landfills.

All of the aforementioned attempts at sealing excavated earth formations have been fraught with drawbacks, and particularly where the excavations are in generally small residential or commercial settings. The clay-like linings require a large quantity of clay to form a seal and have made the cost a prohibitive factor, and especially where the clay and/or sealing materials must be transported to the excavated formation site.

Phosphate slimes require the necessary steps of slime recovery, concentration, and application as well as transporting to a site, and are not practical or economically feasible for residential or commercial settings. The industrial liquid waste materials mixed with loose earth as a lining is only practical at the waste material formation site and would not be available at remote locations nor would it be suitable for use at residential or commercial sites. Reconstituted shale found beneath limestone quarries does not usually exist where one seeks to excavate an earth formation, and particularly not around residential or commercial sites. Additionally, the shale must be mined by drilling, blasting and crushing, requiring significant expenditures for labor and equipment and for transporting the shale to a formation site.

The use of a rubber or plastic membrane alone to line the formations as well as the clay and earthen liners will not prevent tree root penetration through the liners to form openings for leakage of the liquid contents of the formations. Also, these type of liners are susceptible to boring rodents such as chipmunks, mice, muskrats, and such like, where channels or openings would be formed and leakage resulting. Also, the membrane is vulnerable to piercing by rock bodies arranged in the formation or by shale or other rock formation in the earth surrounding the formation. To prevent root and rodent penetration hardenable foam has been used but the root and rodent infiltration has not been completely eliminated.

The present invention overcomes the problems inherent in the existing known liners by providing an effective and inexpensive technique for inhibiting hydraulic leakage from excavated earth formations and particularly for ponds, water gardens, and the like in residential and commercial settings. The technique and method for constructing a substantially hydraulically impervious excavated earthen formation, herein referred to as an'earthen pond or pond, seals the formed pond basin at potentially penetrating locations with few, and readily available, elements. The sealant combination is provided with infiltrating inhibitors to prevent root and/or rodent penetration. The sealant is effectively resistant to penetration by hard objects such as rock or shale bodies, preventing leakage by such penetration. The technique in achieving the sealed earthen pond is relatively simple to apply and the positive sealant effect results quickly after the pond basin is excavated.

### SUMMARY OF THE INVENTION

The present invention provides an hydraulically impervious earthen pond, comprising a shaped man-made excavated pond basin having sides and a base; an impermeable settable hardened foam sealant containing or supporting damaging inhibitor means secured at least to the sides of the pond basin; and a resilient liquid impermeable membrane combination engaging the sealant and the base of the pond basin. The method of the present invention is for constructing a substantially hydraulically impervious earthen pond, comprising the steps of shaping the sides and base of a pond basin; applying at least to the sides of the pond basin a fluid impermeable settable, hardenable foam sealant securing an infiltrating inhibitor means; allowing the sealant to inflexibly set and harden to form an hydraulically impervious seal body between the adjacent earth formation and interior of the pond basin; and covering the sealant and base of the pond basin with a resilient liquid impermeable membrane combination. The infiltrating damaging inhibitor means could be a root inhibitor such as copper sulfate, cupric carbonate or the herbicide trifluralin contained or secured by the sealant. The trifluralin would be in amounts for inhibiting cell division in root tips located in the earth immediately surrounding the pond basin without having any environmental impact beyond the root control area. The infiltrating damaging inhibitor means could be a rodent inhibitor/repellant such as metallic copper particles or a copper wool, difethialone, or chlorophacinone, or a natural deterrent. Both a root inhibitor and rodent inhibitor/repellant could comprise the infiltrating damaging inhibitor means. A typical combined root inhibitor and rodent inhibitor/repellant could be metallic copper particles or copper wool containing copper sulfate. The root inhibitor could be a copper sulfate—soaked synthetic non-woven fabric or a latex paint containing cupric carbonate. In either case the foam sealant would secure or be adhered to the fabric or paint applied to the earth sides or the pond basin. The foam sealant would conform to the surrounding earth formation and where the excavation would be jagged or uneven as may be with excavated shale, for example, the foam would fill the uneven areas. The liquid or powdered inhibitors or repellants could be mixed with the foam prior to applying into the surfaces of the pond basin or applied to the earthen surface of the excavation before applying the foam sealant whereby the foam will contain or secure the earthen surface applied inhibitors.

Various other advantages, details, and modifications of the present invention will become apparent and indicated as the following descriptions of a certain preferred embodiment and certain preferred method of forming the invention proceed.

### BRIEF DESCRIPTION OF THE DRAWINGS

In the accompanying drawings I show a certain present preferred embodiment of my present invention in which:

FIG. 1 is a cross-sectional view of an excavated earthen pond basin embodying the present invention, the pond being hydraulically impervious;

FIG. 2 is a somewhat schematic cross-sectional view of a side section and part of the base of the pond basin of FIG. 1 showing details of construction of the present invention with certain elements being separated for purposes of illustrating their relationship;

FIG. 3 is a somewhat schematic cross-sectional view of a side section and part of the base of a pond basin showing details of construction of a pond basin not embodying the present invention illustrating penetration of a liner by roots, boulders, and rock or shale formations;

FIG. 4 is a plan view of the pond basin of FIG. 1 showing the inner membrane extending around the pond basin with its upper portion removed to show the upper end portion of the inner sealant extending around the pond basin; and

FIG. 5 is a cross-sectional view of a part of the side of the pond basin embodying the present invention showing a root and/or rodent inhibitor in the form of a cloth, wool, or metallic sheet containing a chemical inhibitor (not shown) and metallic particles within the confines of the sealant layer.

### DESCRIPTION OF A PREFERRED EMBODIMENT AND METHOD

Referring now to the drawings, there is shown an excavated earthen hydraulically impervious pond basin 10 embodying the present invention. The pond basin 10, hereinafter referred to as pond 10 is depicted in somewhat schematic form for purposes of clearly illustrating the combination of the elements forming the present invention. The pond 10 could be any type of an earthen excavation for containing hydraulic fluids such as water, for example, in a residential setting such as a fish pond, water garden, or the like. A typical pond 10 would be excavated with a side 12 having somewhat vertical side sections 14 and somewhat horizontal side sections 16, and a base 18.

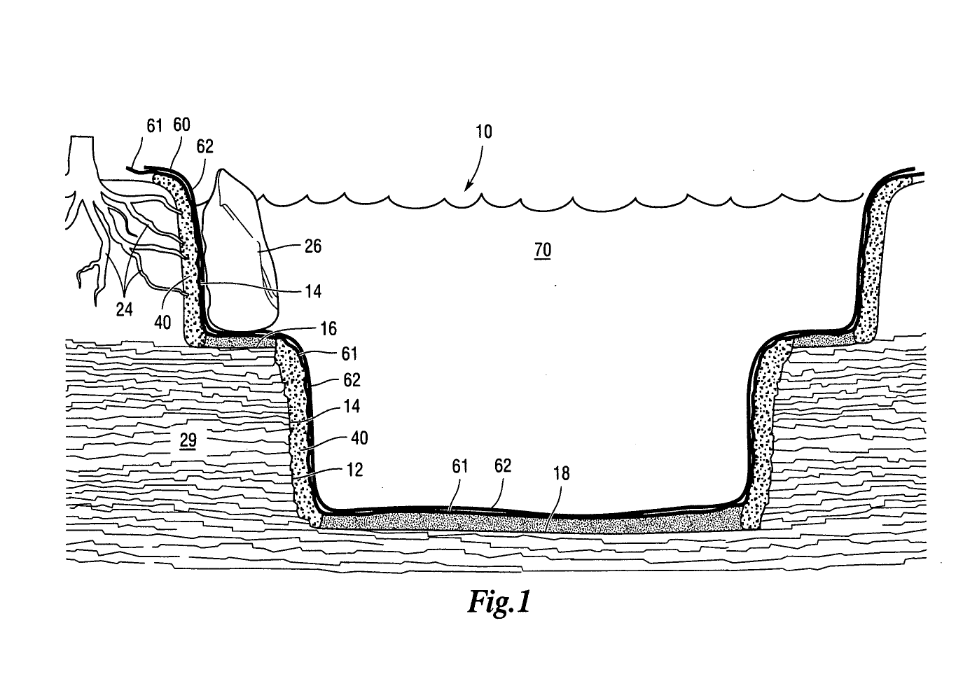

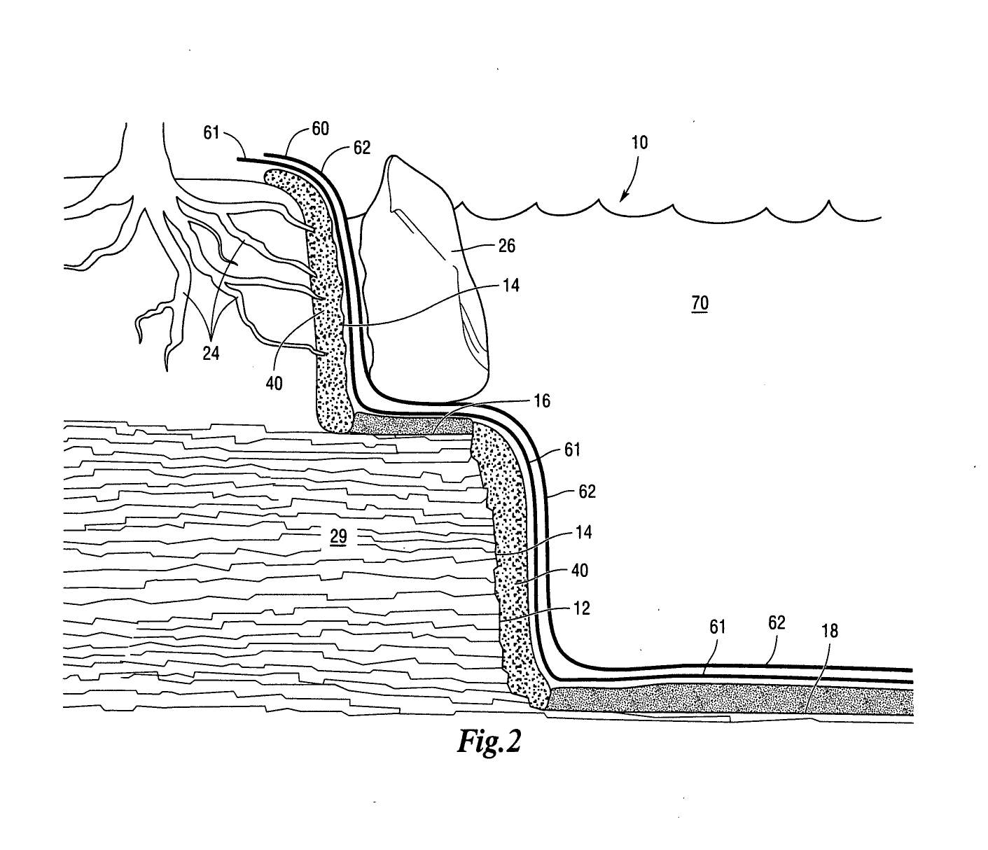

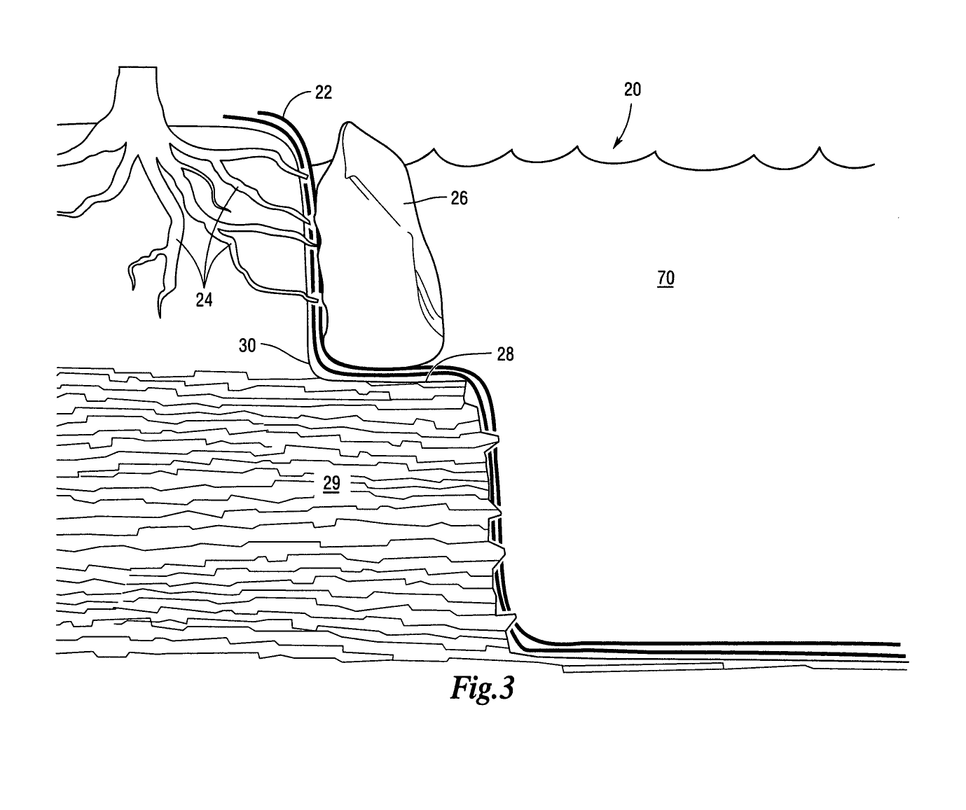

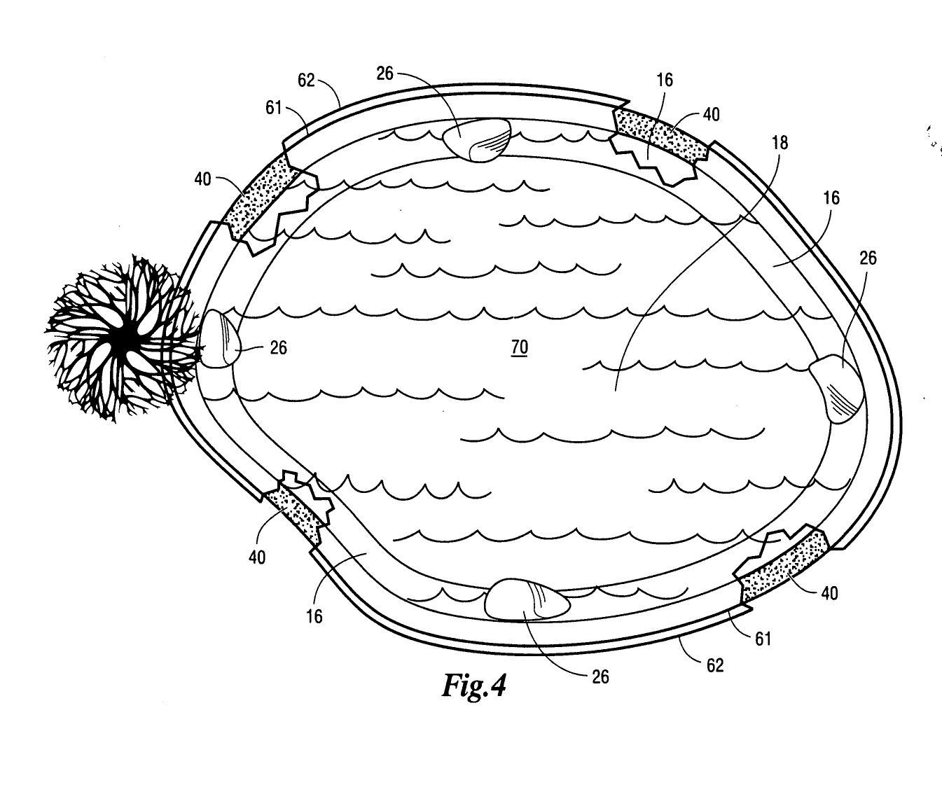

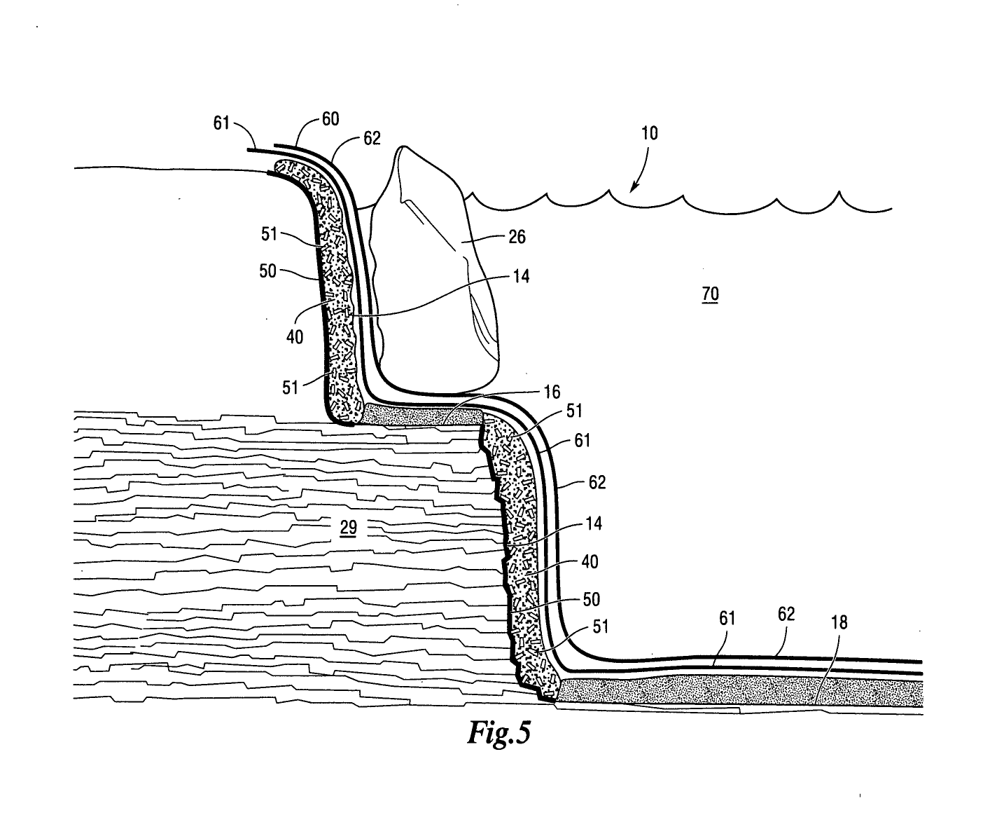

The pond 10 of the present invention is constructed to be hydraulically impervious. A pond 20 as shown schematically in FIG. 3 is susceptible to leakage caused by the penetration of a liner 22 covering the interior of the pond 20. As shown in FIG. 3, tenacious roots 24, decorative jagged boulders 26 arranged on horizontal section 28 of the pond 20, or sharp, pointed rock or shale formations 28, could penetrate the liner 22 at the side sections 30 of the pond 20. Also, but not illustrated, rodents such as chipmunks, muskrats, mice, or such like have been known to gnaw through liner 22 forming leakage openings. FIGS. 1, 2, 4 and 5 show the pond 10 of the present invention hydraulically impervious. After the pond 10 is evacuated in any desired configuration with somewhat vertical side sections 14 and somewhat horizontal side sections 16, hydraulically impermeable, hardenable foam sealant 40 is applied to at least the vertical side section 14 and if desirable to the horizontal section 16. The foam sealant 40 would be typically a polyurethane expandable foam, of well known type, hardenable on exposure to the atmosphere, and which would conform as shown to the surrounding earth formation including filling in any uneven formations such as shale formations 29, as shown in FIG. 2. The foam sealant 40, as shown at its upper end section in FIG. 4, extends around the entire circumference of the pond 10. The foam sealant 40 contains or secures an infiltrating damages inhibitor such as a root inhibitor or rodent inhibitor/repellant, or both. Any known root inhibitor such as copper sulfate, cupric carbonate, or trifluralin could be mixed or combined with the foam sealant 40 prior to the sealant being applied to the side sections 14 and 16 or applied to the earthen surface along the vertical side sections. Rodent inhibitors/repellants of any well known composition could be mixed with the foam sealant 40 before its being applied to the vertical side sections 14. Typical rodent inhibitors/repellants could be defethialone, chlorophacenone, or one of many well-known so-called rodenticides. Natural rodent inhibitors/repellants could be used such as well-known repellants consisting of animal blood, garlic oil, eggs, and peppermint oil, or that containing a large variety of natural oils such as the oils of Spanish rosemary, balsam fir needle, lavender, clary sage, lemon and others. Also, the foam sealant 40 could be applied to the base 18. The inhibitors could also be sprayed onto the earth surface prior to applying the foam sealant 40 with the inhibitor being contained or secured by the sealant 40 at the earthen walls. The inhibitors/repellants could be a liquid, dry powder or granular, as would be well known. In any event, whichever inhibitor/repellant is used, it or they are either mixed with the foam sealant 40 prior to applying it to the sides 12 and base 18, if desired, or sealant 40 contained selected inhibitor/repellant, applied to the earthen sides and base. Should the herbicide trifluralin root inhibitor be used, it should be in an amount sufficient to inhibit cell division in root tips located in the earth immediately adjacent to the pond 10 without having any environmental impact beyond the root control area. A copper sulfate-soaked, synthetic, non-woven fabric, or metallic copper mesh 50 soaked with copper sulfate or a rodenticide could be applied as shown in FIG. 5 to the earth surface sides and contained or secured by the foam sealant 40 and would serve to inhibit root penetration (copper sulfate fabric) and inhibit/repel rodents (copper mesh). Also, cupric carbonate in a latex paint, not shown, could be applied in a thin layer to the earth sides and contained by the foam sealant 40 to serve as a root inhibitor. Reference is made to the publication of Kim D. Code of the University of Georgia, Warnell School of Forest Resources entitled “Root Control Barriers,” and incorporated herein, for detailed description of various root inhibitors and their use including those indicated herein.

Rodent inhibitors in the form of metallic particles 51 could be contained by the foam sealant 40, and would also strengthen the sealant body allowing the use of a thinner body of sealant as compared with a sealant 40 without any metallic particles therein. Should a rodent gnaw at or chew the sealant 40 containing a metallic mesh 50 or metallic particles 51, or smell the chemical repellant, the rodent would be repelled due to the chewing sensation it would realize as it encountered the metal or by the odor of the chemical. The chemical inhibitors/repellants in the sealant 40 or the metallic mesh 50 would serve to deter or repel the rodent from gnawing or chewing the sealant 40, or kill the rodent.

After the foam sealant 40 is applied and hardens with the inhibitors contained by the sealant, a resilient hydraulically impervious membrane 60 is placed on the sealant and throughout the confines of the pond 10, including the vertical side sections 14, horizontal side sections 16, and base 18. In other words, the entire basin of the pond 10 is covered with the membrane 60, which includes a non-woven, geotextile fabric underlayment 61 on the sealant 40 shown clearly in FIG. 2 and an EDPM ethylene propylene diene monomer liner 62 of a well-known nature on the underlayment. The liner 62 could have a thickness of 45 mil which is the most commonly used liner or one of 60 mil thickness. Also, flexible plastic liners could be used such as a plastic type polyvinyl chloride or high density polyethylene. Whichever liner 62 is used it should be essentially hydraulically impervious. The membrane 62 will be secured in place by the hydraulic pressure of the water 70 in the pond 10 exerted on the membrane 60.

The foam sealant 40 is, as noted, of any well-known composition and may be a polyurethane which chemically cures (i.e. hardens) upon exposure to the atmosphere. A typical foam sealant 40 expands and becomes tack-free in thirty to sixty seconds and will be completely cured in minutes depending on the atmospheric temperature. Under any condition the sealant 40 hardens relatively quickly, usually in seconds. The sealant 40 expands to fill cavities, or uneven surfaces as shown. The contained inhibitors and repellants resist animal penetration. The sealant also cushions the membrane 60 from possible punctures caused by roots, sharp objects, and hard surfaces.

Typically a hydraulically impervious pond 10 would be formed by initially determining the best location. The site would be leveled using a transit and the water level established. The area would be laid out for any plumbing, mechanical, non-mechanical and biological devices. The basin of the pond 10 would be excavated as would be any desired features such as a waterfall, rain harvest, water retention area, and water courses. The vertical and horizontal areas such as those shown in the drawings would be cleared of any protruding roots, stones, or sharp formations all of which would be potential leak hazards. The foam sealant 40 would be applied to at least the vertical side sections 14 and if desired or deemed necessary to the horizontal side sections 16 and base 18. The foam sealant 40 would typically be contained in a pressurized vessel, and would be applied to fill any cavities, hard areas, and any potential leak areas such as might be on the horizontal side sections 16 where boulder or decorative objects might be positioned. Should waterfall zones and pooling areas be formed within the pond 10, sealant 40 could be applied. Any excess sealant 40 or unwanted sealant 40 would be trimmed. If deemed necessary or desired, sealant 40 may be applied to existing sealed areas to provide proper additional sealing. The foam sealant 40 will harden quickly, typically between thirty and sixty seconds, and when sufficiently hardened an underlayment 61 would be placed on the sealant 40 followed by the emplacing of the flexible rubber or plastic membrane 62. Before doing the final finishing, decorative objects, such as boulders 26, as shown in the drawing, could be placed on the horizontal side sections 16. The pond 10 would then be in condition for filling with water 70. The sealant 40 could contain any root or rodent inhibitor, or both, each could have been mixed in the foam sealant 40 prior to or as it was being applied to the surfaces of the pond 10. The inhibitors could be applied directly to the earth surface of the sides prior to applying the foam sealant 40 whereby the sealant would contain the earth surface applied inhibitors, as was previously described herein, with respect to FIG. 5.

It should now be clearly apparent how the assembled pond 10 of my present invention is hydraulically impervious, and is resistant to any penetration or infiltration into the interior of the pond 10, thereby preventing any unwanted leakage as would occur in the pond illustrated in FIG. 3. The sealant 40 and the root and rodent inhibitors contained by or in the sealant 40 together with the membrane 62/underlayment 61 combination (membrane 60) would provide a completely sealed and protected pond. Various modifications of the pond 10 of my invention should be apparent to those skilled in the art. For example, foam sealants 40 of varying densities and strength properties could be used whereby stronger sealants would require less amounts providing thinner layers than less stronger sealants with the same protection.

While I have described a certain present embodiment of my invention and a present preferred method of forming my invention, it is to be distinctly understood that the invention is not limited thereto but may be otherwise embodied or practiced within the scope of the following claims.

I claim:

1. A method of constructing a substantially hydraulically impervious earthen pond, comprising the steps of:
shaping by excavating the sides and base of a pond basin;
applying at least to the sides of said pond basin a fluid hydraulically impermeable, settable, hardenable foam sealant securing an infiltrating damaging inhibitor means;
allowing said sealant to inflexibly set and harden to form an hydraulically impervious seal body between the adjacent earth formation and interior of said pond basin; and
covering the sealant and base of said pond basin with a resilient liquid impermeable membrane means.

2. The method of constructing a substantially hydraulically impervious earthen pond as set forth in claim 1 wherein the applying step is with a polyurethane expandable foam settable and hardenable on exposure to the atmosphere.

3. The method of constructing a substantially hydraulically impervious earthen pond as set forth in claim 1 wherein the applying step is with said sealant supporting a rodent inhibitor means.

4. The method constructing a substantially hydraulically impervious earthen pond as set forth in claim 1 wherein the applying step is with said sealant supporting a root inhibitor means.

5. The method of constructing a substantially hydraulically impervious earthen pond as set forth in claim 1 wherein the covering step is with a liquid impermeable rubber and geotextile fabric membrane combination.

6. The method of constructing a substantially hydraulically impervious earthen pond as set forth in claim 1 wherein the applying step is with said sealant supporting both rodent and root inhibitor means.

7. The method of constructing a substantially hydraulically impervious earthen pond as set forth in claim 3 wherein said rodent inhibitor means is metallic copper.

8. The method of constructing a substantially hydraulically impervious earthen pond as set forth in claim 4 wherein said root inhibitor means is either copper sulfate or cupric carbonate.

9. The method of constructing a substantially hydraulically impervious earthen pond as set forth in claim 1 wherein the applying step is with said sealant containing a combined metallic copper and copper sulfate root and rodent inhibitor.

10. The method of constructing a substantially hydraulically impervious earthen pond as set forth in claim 1 wherein the applying step is with a sealant containing the herbicide trifluralin root inhibitor in an amount for inhibiting cell division in root tips located immediately in the earth surrounding the pond basin without having any environmental impact beyond the root control area.

11. An hydraulically impervious earthen pond, comprising
a shaped man-made excavated pond basin having sides and a base;
an impermeable settlable hardened foam sealant supporting damaging inhibitor means secured at least to the sides of said pond basin; and
a resilient liquid impermeable membrane means engaging the sealant and base of said pond basin.

12. The hydraulically impervious earthen pond as set forth in claim 11 wherein said damaging inhibitor means contains a rodent inhibitor.

13. The hydraulically impervious earthen pond as set forth in claim 11 wherein said damaging inhibitor means contains a root inhibitor.

14. The hydraulically impervious earthen pond as set forth in claim 11 wherein said inhibitor means contains both rodent and root inhibitors.

15. The hydraulically impervious earthen pond as set forth in claim 12 wherein said rodent inhibitor is metallic copper.

16. The hydraulically impervious earthen pond as set forth in claim 13 wherein said root inhibitor is either copper sulfate or cupric carbonate.

17. The hydraulically impervious earthen pond as set forth in claim 11 wherein said sealant contains the herbicide trifluralin root inhibitor in an amount for inhibiting cell division in root tips located immediately in the earth surrounding the pond basin without having any environmental impact beyond the root control area.

18. The hydraulically impervious earthen pond as set forth in claim 11 wherein said membrane means is a combined layered geotextile fabric and rubber membrane.
